(19) United States
(12) Patent Application Publication
(10) Pub. No.: US 2009/0239048 A1
(43) Pub. Date: Sep. 24, 2009

(54) Optical Articles

(75) Inventors: Yosuke SUGIHARA, Suwa-shi (JP); Shuji NAITO, Ina-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/368,129

(22) Filed: Feb. 9, 2009

(30) Foreign Application Priority Data
Mar. 24, 2008 (JP) 2008-075106
Sep. 11, 2008 (JP) 2008-232976

(51) Int. Cl. B32B 7/02

(52) U.S. Cl. 428/212

(57) ABSTRACT

An optical article includes a plastic substrate, a first layer which is adjacent to the plastic substrate and the refractive index of which decreases in the direction to be remoter from the plastic substrate, a second layer which is adjacent to the first layer and the refractive index of which is not higher than the refractive index of the surface part of the first layer, and a hard coat layer which is adjacent to the second layer and the refractive index of which is lower than the refractive index of the plastic substrate.

### BACKGROUND

1. Technical Field

The present invention relates to an optical article favorably usable for plastic lenses for spectacles, cameras, etc.

2. Related Art

A plastic lens is, as compared with a glass lens, lightweight and is excellent in shapability, workability and tintability, and in addition, it hardly cracks and is highly safe. Accordingly, a plastic lens has become promptly popularized in the field of spectacle lenses, and at present, it occupies the major part of those lenses. Recently, in addition, high-refractivity materials such as thiourethane resin and episulfide resin have been developed for satisfying the requirement for thinner and more lightweight lenses.

JP-A 2004-002712 and 2005-281527 propose a method for producing an episulfide resin having a high refractive index by polymerizing an epithio group-having compound (episulfide compound) in the presence of sulfur. The episulfide resin can easily express a high refractive index of at least 1.7, and is effective for thinned spectacle lenses.

As optical articles including spectacle lenses, known are those comprising, as formed on the surface of a plastic substrate, a primer layer mainly for imparting adhesiveness and impact resistance thereto, and comprising, as formed on the surface of the primer layer, a hard coat layer mainly for imparting scratch resistance and abrasion resistance thereto. In such optical articles, where the refractive index of the plastic substrate is increased, the primer layer ad the hard coat layer must have a refractive index on the same level as that of the plastic substrate for preventing the generation of interference fringes.

For example, in general, any of various metal oxides is added to a hard coat layer as a filler therein, to thereby make the hard coat layer have an increased high refractive index. The metal oxides include simple or composite particles of titanium oxide, zirconium oxide, antimony oxide, tin oxide and the like. Generally, metal oxides are poorly resistant to light and tend to be colored, and therefore, from the viewpoint of the transparency and the safety in a visible light region, titanium oxide is mainly used.

However, titanium oxide has a property of expressing a photocatalytic effect when having received UV rays; and therefore, in case where it is used in a hard coat layer as a filler therein, titanium oxide may decompose the binder ingredient of an organic resin around it to cause delamination of the hard coat layer. Accordingly, in the hard coat layer, not anatase-type titanium oxide that readily expresses a photocatalytic effect but rutile-type one having a relatively small photocatalytic effect is often used as disclosed in JP-A-2007-102096.

As described in the above, when the refractive index of a plastic substrate differs from that of a hard coat layer and/or a primer layer, then interference fringes may be generated owing to the difference in the refractive index. The recent presentation of a high-refractivity plastic substrate having a refractive index of more than 1.7 has brought about a technique of increasing the refractive index of not only a hard coat layer but also a primer layer, for preventing interference fringes.

Metal oxide particles (metal oxide sol) in the corresponding coating compositions participate in increasing the refractive index of the hard coat layer and the primer layer. Specifically, for increasing the refractive index, the compositional ratio of metal oxide particles must be increased, or metal oxide particles themselves must have a high refractive index. Some investigations have been made for increasing the refractive index of metal oxide particles themselves, but are insufficient. Accordingly, for increasing the refractive index of a hard coat layer and a primer layer, at present, the compositional ratio of metal oxide particles must be increased. A high-refractivity lens material is relatively brittle and weak, and therefore, for making it have sufficient shock absorbability, a primer layer is preferably provided. The shock absorbability of the primer layer is given by the resin ingredient in the primer composition (coating film composition), but as so mentioned in the above, when the proportion of the metal oxide particles in the layer is increased for the purpose of making the layer have an elevated high refractive index, the layer could not sufficiently exhibit the shock absorbability thereof.

### SUMMARY

An advantage of some aspects of the invention is to provide an optical article using a high-refractivity plastic substrate, which can prevent the generation of interference fringes and has good impact resistance.

According to an aspect of the invention, there is provided an optical article including a plastic substrate, a first layer which is adjacent to the plastic substrate and the refractive index of which decreases in the direction to be remoter from the plastic substrate, a second layer which is adjacent to the first layer and the refractive index of which is not higher than the refractive index of the surface part of the first layer, or that is, the same as or lower than the refractive index of the surface part of the first layer, and a hard coat layer which is adjacent to the second layer and the refractive index of which is lower than the refractive index of the plastic substrate.

The optical article basically includes a plastic substrate, a hard coat layer, and first and second layers sandwiched between the plastic substrate and the hard coat layer. Accordingly, the first and second layers may function as a primer layer, or that is, may function to satisfy both adhesiveness and impact resistance. The first layer the refractive index of which decreases in the direction to be remoter from the plastic substrate is made to function for refractivity control to prevent interference fringes, and therefore, this may relax the requirement for increasing the refractive index of the second layer. Accordingly, in the second layer, the requirement for increasing the proportion of metal oxide particles can be relaxed, and the second layer can fully exhibit the shock absorbability thereof. Further, since the requirement for increasing the refractive index of the second layer can be relaxed, the requirement for increasing the refractive index of the hard coat layer can also be relaxed.

Specifically, in the optical article, the first layer can give mainly adhesiveness and a function for refractivity control to prevent interference fringes. The second layer may give mainly impact resistance, or that is, shock absorbability. In addition, a hard coat layer that is harder than the first and second layers is provided, as laid on the second layer, and therefore can give scratch resistance and abrasion resistance. Further, since the first layer can relax the requirement for increasing the refractive index of the second layer and can relax the requirement for increasing the refractive index of the hard coat layer, the refractive index of the second layer and the hard coat layer to be laminated on the first layer may be made lower than the refractive index of the plastic substrate. Accordingly, the latitude in constitution of the layers, choice for the compositions to form the layers, and layer planning can be broadened. To that effect, according to an aspect of the invention, there is provided an optical article having a high refractive index, which can prevent the generation of interference fringes and has good durability including impact resistance, scratch resistance and abrasion resistance.

In one aspect of the optical article of the invention, the plastic substrate is one formed through polymerization and curing of a polymerizing compound comprising an episulfide compound as the main ingredient thereof, and has a refractive index of at least 1.7. Since the optical article has a high refractive index of at least 1.7, and can be readily thinned, and in addition, it is excellent in impact resistance and generates few interference fringes. Accordingly, the optical article can be widely used as various thin optical lenses such as typically spectacle lenses as well as camera lenses, lenses for telescopes, lenses for microscopes, condenser lenses for steppers, etc.

In the optical article, one typical embodiment of the first layer is formed of a first material comprising (A) a polyurethane resin, (B) metal oxide particles, and (C) an organosilicon compound. In this case, the first layer may be formed, for example, according to a dip coating method, a spin coating method, a spraying method or the like. When the first layer is formed of the first material, then the refractive index of the top (surface) of the first layer can be lower than the refractive index of the bottom (base) thereof to be the interface to the underlying support (substrate) and/or the refractive index of the inside (inner part) of the first layer. Accordingly, the refractive index from the substrate to the hard coat layer via the first layer can be continuously or stepwise (intermittently) lowered.

In the optical article, one embodiment of the second layer is formed of a second material comprising (D) an urethane-based, ester-based, epoxy-based, acryl-based or silicone-based organic resin, and (E) metal oxide particles. In this case, for better adhesiveness of the layer, the ingredient (D) is preferably an urethane-based or ester-based organic resin. The second layer may be formed, for example, according to a dip coating method, a spin coating method, a spraying method or the like.

In the optical article, one embodiment of the hard coat layer is formed of a third material comprising (F) an organosilicon compound and (G) metal oxide particles. For the ingredient (F), for example, a silicone-based curable resin can be used. In this case, the third material may optionally contain (H) an additive such as colorant, UV absorbent, antioxidant, etc.

In the optical article, where the first material to form the first layer, the second material to form the second layer and the third material to form the hard coat layer each contain metal oxide particles and an organic resin, the proportion of the metal oxide particles to the organic resin in the first material is preferably larger than the proportion of the metal oxide particles to the organic resin in the second layer. In this case, the first layer nearer the plastic substrate may have a higher refractive index and the second layer may have high impact resistance. In this case, the proportion of the metal oxide particles to the organic resin in the third material may be larger than the proportion of the metal oxide particles to the organic resin in the second material.

### BRIEF DESCRIPTION OF THE DRAWINGS

The invention will be described with reference to the accompanying drawings, wherein like numbers reference like elements.

FIG. 1 is a graphical view showing a plastic lens as an optical article of one embodiment of the invention.

FIG. 2 is a table showing, as summarized, the refractive index of the plastic lens substrate, and the compositional ratio, the thickness and the refractive index of each layer of the plastic lenses of Examples 1 to 7 and Comparative Examples 1 and 2.

FIG. 3 is a table showing, as summarized, the test results of the plastic lenses of Examples 1 to 7 and Comparative Examples 1 and 2.

### DESCRIPTION OF EXEMPLARY EMBODIMENTS

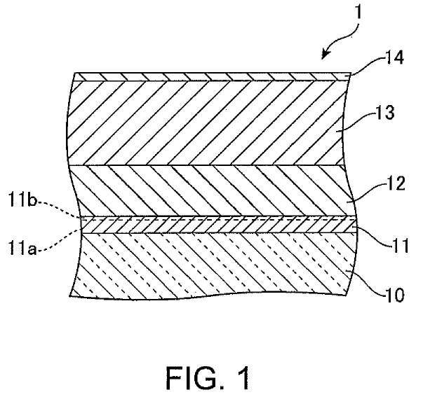

Embodiments of the optical article of the invention are described below. FIG. 1 graphically shows an optical article according to one embodiment of the invention. The optical article 1 of this embodiment is, for example, a spectacle lens (plastic lens for spectacles. The plastic lens 1 of this embodiment comprises a plastic lens substrate 10, a first layer 11 formed on the surface of the plastic lens substrate 10 to be adjacent to the plastic lens substrate 10, a second layer 12 formed on the surface of the first layer 11 to be adjacent to the first layer 11, and a hard coat layer 13 formed on the surface of the second layer 12 to be adjacent to the second layer 12. Since the plastic lens 1 of this embodiment is a spectacle lens, it further has an antireflection layer 14 formed on the surface of the hard coat layer 13 to be adjacent to the hard coat layer 13. An antifouling layer may be provided on the surface of the antireflection layer 14.

The first layer 11 is a layer the refractive index of which decreases in the direction to be remoter from the plastic substrate 10; and one typical embodiment of the first layer 11 is a layer formed of a first material that comprises (A) a polyurethane resin, (B) metal oxide particles, and (C) an organosilicon compound. The mechanism of the expression of the gradient refractive index of the first layer 11 formed of the first material may be presumed as follows: Specifically, in drying the first material after coating, the polyurethane resin of the ingredient (A) cures relatively earlier than the metal oxide particles of the ingredient (B) in the surface layer thereof. Then, gradually toward the inside part, the metal oxide particles of the ingredient (B) begin to cure along with the ingredient (A). Accordingly, the layer thus formed is such that the ingredient (A) is relatively more in the surface thereof and the ingredient (B) is relatively more in the inside part thereof. Specifically, the refractive index of the layer thus formed decreases in the direction to be remoter from the plastic substrate.

The first material contains an organosilicon compound as the ingredient (C), in addition to the polyurethane resin of the ingredient (A) and the metal oxide particles of the ingredient (B). Accordingly, the voids in the first layer may be filled with the organosilicon compound (ingredient (C)), and the density of the inside part of the first layer is thereby increased. As the ingredient (B), titanium oxide may be used. However, even though titanium oxide is not used, or even when a small amount of titanium oxide is made to exist in the layer, the refractive index of the first layer 11 can be increased, and the generation of interference fringes can be thereby prevented. When the amount of titanium oxide to be used is reduced, then the photoactive effect of the layer may be reduced and the light resistance thereof may be thereby enhanced. Further, since the first material contains a polyurethane resin (ingredient (A)), the first layer 11 formed of the first material contributes toward impact resistance enhancement. The first layer 11 may be formed, for example, according to a dip coating method, a spin coating method, a spraying method or the like.

Another example of the first layer the refractive index of which decreases in the direction to be remoter from the plastic substrate is one formed according to an inkjet method. Specifically, plural (at least two) substances having a different refractive index from each other are individually formed into fine droplets and jetted out toward a plastic substrate with controlling the jetting ratio thereof, thereby forming a first layer the refractive index of which decreases continuously or stepwise in the direction to be remoter from the plastic substrate.

Still another example of the first layer the refractive index of which decreases in the direction to be remoter from the plastic substrate is one formed according to a CVD method. Specifically, plural (at least two) substances having a different refractive index from each other are deposited on a plastic substrate in such a manner that the deposition ratio of those substances could vary in the thickness direction, thereby forming a first layer the refractive index of which decreases continuously or stepwise in the direction to be remoter from the plastic substrate.

Still another example of the first layer the refractive index of which decreases in the direction to be remoter from the plastic substrate is one formed according to an ion plating method. Specifically, during film formation, a reactive gas is introduced into the system while its flow rate is controlled, whereby the refractive index of the layer to be formed is varied in the thickness direction thereof. Accordingly, a first layer can be formed the refractive index of which decreases continuously or stepwise in the direction to be remoter from the plastic substrate.

As in FIG. 1, the first layer 11 and the second layer 12 are provided between the plastic lens substrate 10 and the hard coat layer 13, and as a whole, they function as a primer layer that satisfies both adhesiveness and impact resistance. The first layer 11 functions as a primer layer (refractivity controlling layer) mainly for attaining adhesiveness and for refractivity control. The first layer 11 is referred to as a first primer layer. The refractive index of the first primer layer 11 decreases in the direction to be remoter from the plastic lens substrate 10. The difference between the refractive index of the first primer layer 11 near to or in the boundary (interface, base) thereof to the plastic lens substrate 10 and the refractive index of the plastic lens substrate 10 is preferably at most 0.01. In this embodiment, the refractive index of the inside part (the part on the side of the plastic lens substrate 10) 11a of the first primer layer 11 is, for example, on the same level as that of the refractive index of the plastic lens substrate 10.

The second layer 12 functions as a primer layer (shock absorbing layer) for attaining the adhesiveness between the plastic lens substrate 10 and the hard coat layer 13 and mainly for absorbing shock. Hereinafter the second layer 12 is referred to as a second primer layer. The refractive index of the second primer layer 12 is not higher than the refractive index of the surface part 11b of the first primer layer 11. In this embodiment, the refractive index of the second primer layer 12 is, for example, on the same level as that of the refractive index of the surface part 11b of the first primer layer 11.

The hard coat layer 13 is a layer for giving scratch resistance and abrasion resistance. The hard coat layer 13 is so formed that it can be a harder layer than the first primer layer 11 and the second primer layer 12. The refractive index of the hard coat layer 13 is smaller than the refractive index of the plastic lens substrate 10. In this embodiment, the refractive index of the hare coat layer 13 is, for example, on the same level as that of the refractive index of the second primer layer 12.

Accordingly, the spectacle lens 1 of this embodiment includes a coat layer for the purpose of giving impact resistance and adhesiveness, or that is, a primer layer (first primer layer, second primer layer), and a coat layer for the purpose of giving scratch resistance and abrasion resistance, or that is, a hard coat layer. The primer layer (first primer layer, second primer layer) may be defined as a layer to be disposed nearer to the lens substrate than the hard coat layer for securing adhesiveness. The hard coat layer may be defined as a harder layer than the primer layer (first primer layer, second primer layer).

The plastic lens substrate 10, the first primer layer 11, the second primer layer 12, the hard coat layer 13, the antireflection layer 14 and the antifouling layer are described in more detail hereinunder.

### 1. Lens Substrate

Not specifically defined, the plastic lens substrate 10 may be formed of any plastic resin. In case where the optical article 1 is a spectacle lens (plastic lens for spectacles), a lens substrate of high refractivity is preferred for it as capable of reducing the thickness thereof and further for attaining a refractivity difference between the plastic lens substrate 10 and the antireflection layer 14 to be formed on the surface of the plastic lens substrate 10. The refractive index of the plastic lens substrate 10 for spectacle lenses is preferably at least 1.65, more preferably at least 1.7, even more preferably at least 1.74, most preferably at least 1.76.

The lens material having a refractive index of at least 1.65 includes a polythiourethane-based plastic to be produced by reacting a compound having an isocyanate group or an isothiocyanate group and a compound having a mercapto group, an episulfide-based plastic to be produced by polymerizing and curing a starting monomer that includes a compound having an episulfide group, etc.

The compound having an isocyanate group or an isothiocyanate group to be the main ingredient of the polythiourethane-based plastic may be any known compound. Specific examples of the compound having an isocyanate group include ethylene diisocyanate, trimethylene diisocyanate, 2,4,4-trimethylhexane diisocyanate, hexamethylene diisocyanate, m-xylylene diisocyanate, etc.

The compound having a mercapto compound may also be any known compound. Specific examples of the compound having a mercapto compound include an aliphatic polythiol such as 1,2-ethanedithiol, 1,6-hexanedithiol and 1,1-cyclohexanedithiol; and an aromatic polythiol such as 1,2-dimercaptobenzene and 1,2,3-tris(mercaptomethyl)benzene.

For increasing the refractive index of the plastic lens substrate 10, a polythiol containing a sulfur atom in addition to a mercapto group is more preferred. Its specific examples include 1,2-bis(mercaptomethylthio)benzene, 1,2,3-tris(mercaptoethylthio)benzene, 1,2-bis((2-mercaptoethyl)thio)-3-mercaptopropane, etc.

As the plastic lens substrate 10, also preferred is one produced by polymerizing and curing a polymerizing composition comprising an episulfide compound as the main ingredient thereof, thereby to have a refractive index of at least 1.7, more preferably more than 1.7.

As the episulfide compound, usable is any known episulfide group-having compound with no limitation. Specific examples of the episulfide compound include an episulfide compound to be derived from an already-existing epoxy compound by substituting partly or wholly the oxygen atom of the epoxy group therein with a sulfur atom, etc. For increasing the refractive index of the plastic lens substrate 10, use of a compound containing a sulfur atom in addition to an episulfide group is preferred. Its specific examples include 1,2-bis(β-epithiopropylthio) ethane, bis(β-epithiopropyl)sulfide, 1,4-bis(β-epithiopropylthiomethyl)benzene, 2,5-bis(β-epithiopropylthiomethyl)-1,4-dithiane, bis(β-epithiopropyl) disulfide, etc. One or more of these episulfide compounds may be used either singly or as combined.

The plastic lens substrate 10 may be formed through casting polymerization comprising, for example, mixing the above-mentioned episulfide compound as a monomer and a predetermined catalyst and further sulfur, followed by casting the mixture into a glass-made or metal-made mold. The polymerization in the presence of sulfur gives a high-refractivity plastic lens substrate 10 having a refractive index of at least 1.74. In mixing sulfur in the polymerization system, the amount of sulfur is preferably from 0.1 to 25 parts by weight relative to 100 parts by weight of the episulfide compound, more preferably from 1 to 20 parts by weight.

The catalyst to be used in polymerization includes amines, phosphines, quaternary ammonium salts, quaternary phosphonium salts, tertiary sulfonium salts, secondary iodonium salts, mineral acids, Lewis acids, organic acids, silicic acids, tetrafluoroboric acids, etc. Of those, examples of preferred catalysts include amines such as aminoethanol and 1-aminopropanol; quaternary ammonium salts such as tetrabutylammonium bromide; quaternary phosphonium salts such as tetramethylphosphonium chloride and tetramethylphosphonium bromide; etc.

The catalyst to be used in polymerization must be selected in accordance with the type of the monomer to be used and its amount to be added must also be controlled in accordance with it. Typically, a range of from 0.001 to 0.1% by weight based on the total amount of the starting material for the plastic lens substrate 10 is preferred.

The polymerization temperature is preferably from 5 to 120° C. or so; and the reaction time may be from 1 to 72 hours or so. Preferably, the polymerization is followed by annealing at 50 to 150° C. for 10 minutes to 5 hours or so, for strain removal from the plastic lens substrate 10.

In preparing the polymerizing composition for forming the plastic lens substrate 10, a polyisocyanate compound and/or a polythiol compound is preferably mixed therein as an additional monomer. In case where a polyisocyanate compound and/or a polythiol compound is mixed in the episulfide compound, not only the episulfide compound but also the polyisocyanate compound and the polythiol compound participate in polymerization. Accordingly, a plastic lens substrate 10 more excellent in tintability and heat resistance can be obtained.

The polymerizing composition to form the plastic lens substrate 10 may optionally contain various known additives such as UV absorbent, IR absorbent, light stabilizer, internal release agent, antioxidant, dye, photochromic dye, pigment, antistatic agent, etc.

### 2. First Primer Layer

The first primer layer 11 is formed on the surface of the plastic lens substrate 10, and has a property of controlling the refractive index of the structure. The first primer layer 11 also has a property of exhibiting the adhesiveness between the plastic lens substrate 10 and the hard coat layer 13 and the impact resistance of the structure.

The first primer layer 11 is, for example, formed of a first material comprising the following ingredients (A) to (C) (first coating composition, first primer composition, first film-forming composition):

(A) Polyurethane resin,

(B) Metal oxide particles (metal oxide sol), and

(C) organosilicon compound.

Not only the ingredient (B), but also the ingredient (A) and the ingredient (C) exist as particles in the coating composition. In this case, the mean particle diameter (mean particle size) of the ingredient (A) and the ingredient (B) is preferably from 5 to 50 nm; and the mean particle diameter (mean particle size) of the ingredient (C) is preferably 5 nm or so. Falling within the range, the refractive index of the first primer layer 11 nearer to the plastic lens substrate 10 may be made higher. As a result, even when a high-refractivity plastic lens substrate 10 having a refractive index of at least 1.7 is used, the generation of interference fringes may be effectively prevented.

The effect and the mechanism may be presumed as follows: First, even though the refractive index of the metal oxide particles of the ingredient (B) is increased or the blend ratio thereof is increased in the absence of an organosilicon compound of the ingredient (C), the refractive index of the first primer layer 11 could not increase so much. As opposed to this, when the mean particle size of the ingredients (A) to (C) is defined as in the above, the ingredient (C) may penetrate into the voids (pores) formed by the particles of the ingredient (A) and the particles of the ingredient (B). As a result, the first primer layer 11 can be a denser layer, therefore capable of having an increased refractive index. Specifically, it is considered that the ingredient (C) contributes toward increasing the refractive index of the layer. The mean particle size of the ingredients (A) to (C) can be determined according to a light scattering method. For example, using a dynamic light-scattering particle sizer (Horiba Seisakusho's trade name, LB-550), the particle size distribution and the mean particle size can be determined.

The polyurethane resin for the ingredient (A) is an organic resin component, and expresses good adhesiveness between the plastic lens substrate 10 and the hard coat layer 13. As compared with any other resin such as polyester resin, the polyurethane resin is more effective for enhancing the light resistance and the impact resistance of the layer.

The polyurethane resin for the ingredient (A) is not specifically defined. As the polyurethane resin for the ingredient (A), for example, preferred is a water-soluble or water-dispersible polyurethane resin to be obtained by reacting a diisocyanate compound and a diol compound. One or more polyurethane resins may be used for the ingredient (A).

The diisocyanate compound includes, for example, an alicyclic diisocyanate compound such as hexamethylene diisocyanate, 2,2,4-trimethylhexamethylene diisocyanate, hydrogenated xylylene diisocyanate, 1,4-cyclohexane diisocyanate and 4,4-dicyclohexylmethane diisocyanate; an aromatic aliphatic diisocyanate compound such as xylylene diisocyanate and tetramethylxylylene diisocyanate; an aromatic diisocyanate compound such as toluylene diisocyanate and phenylmethane diisocyanate; modified derivatives from these diisocyanates (carbodiimide, uretodione, uretoimine-containing modified derivatives, etc.); etc.

The diol compound includes, for example, a diol compound to be obtained by (co)polymerizing an alkylene oxide such as ethylene oxide or propylene oxide and a heterocyclic ether such as tetrahydrofuran. Specific example of the diol compound include polyether diols such as polyethylene glycol, polypropylene glycol, polytetramethylene ether glycol and polyhexamethylene ether glycol; polyester diols such as polyethylene adipate, polybutylene adipate, polyneopentyl adipate, poly-3-methylpentyl adipate, polyethylene/butylene adipate and polyneopentyl/hexyl adipate; polylactone diols such as polycaprolactone diol; and polycarbonate diols. Of those diol compounds, preferred is use of at least one of polyether-based, polyester-based and polycarbonate-based diols.

As the polyurethane resin for the ingredient (A), preferred are polyether-based polyurethane resins, polyester-based polyurethane resins and polycarbonate-based polyurethane resins to be produced by the use of polyether-based, polyester-based and polycarbonate-based diols as the diol compound.

The morphology of the polyurethane resin for the ingredient (A) is not specifically defined. Typically mentioned is an emulsion-type resin, for example, a self-emulsifiable emulsion-type resin or a self-stabilizing resin. In particular, polyurethane resins produced by the use of a diol having an acid group such as a carboxylic acid group or a sulfonic acid group of the above-mentioned compounds, or those produced by adding a polyhydroxy compound having a low molecular weight thereto, or those with an acid group introduced thereinto, especially those having a carboxyl group are preferred. Also preferably, a functional group such as carboxyl group is crosslinked with the resins through crosslinking treatment for further enhancing the glossiness and the scratch resistance of the structure.

The polyurethane resin for the ingredient (A) exists as particles in the first material (first coating composition); and the mean particle size of the particles is preferably from 5 to 50 nm as so mentioned in the above. More preferably, it is from 20 to 30 nm. When the mean particle size of the polyurethane resin is less than 5 nm or more than 50 nm, then the resin could not exhibit a synergistic effect with the ingredient (B) and the ingredient (C) to be mentioned hereinunder, and it is difficult to effectively increase the refractive index of the first primer layer 11. The particle size of the polyurethane resin for the ingredient (A) may be controlled by controlling the production condition and the molecular weight of the polyurethane resin and by controlling the stirring speed of the first material (first coating composition). The mean particle size of the polyurethane resin for the ingredient (A) as particles can be determined according to a light scattering method as so mentioned in the above.

The blend ratio of the polyurethane resin for the ingredient (A) (the proportion of the ingredient (A) in the first material (first coating composition), the proportion of the ingredient (A) to all the ingredients (A) to (C)) is preferably within a range of from 20 to 60% by weight, more preferably from 30 to 50% by weight. In case where the optical article 1 is a spectacle lens as in this embodiment, and when the blend ratio of the polyurethane resin for the ingredient (A) is less than 20% by weight, then the impact resistance and the light resistance of the optical article 1 to be finally constructed may be insufficient. When the blend ratio of the polyurethane resin for the ingredient (A) is more than 60% by weight, then the refractive index of the first primer layer 11 may lower and the layer may readily generate interference fringes. In addition, when the optical article 1 is a spectacle lens, the outward appearance of the spectacle lens 1 may worsen.

Preferred examples of the polyurethane resin for the ingredient (A) include NeoRezR-960 (manufactured by Zeneca), Hydran AP-30 (manufactured by Dai-Nippon Ink Industry), SuperFlex 210 (manufactured by Daiichi Kogyo Seiyaku), Izelax S-1020 (manufactured by Hodogaya Chemical), Neotan UE-5000 (manufactured by Toa Gosei), RU-40 series (manufactured by Stal Japan), WF-41 series (manufactured by Stal Japan), WPC-101 (manufactured by Nippon Urethane Industry), etc.

The metal oxide particles for the ingredient (B) contribute toward increasing the refractive index of the first primer layer 11 and act as a filler to increase the crosslinking density of the first primer layer 11, thereby contributing toward enhancing the water resistance, the weather resistance and the light resistance of the layer.

As the metal oxide particles for the ingredient (B), preferred are particles containing titanium oxide, and more preferred are metal oxide particles comprising, as the main ingredient thereof, titanium oxide and having a rutile-type crystal structure. Especially from the viewpoint of the light resistance thereof, even more preferred are composite metal oxide particles containing titanium oxide and having a rutile-type crystal structure. Composite metal oxide particles are, for example, those comprising titanium oxide and tin oxide, or titanium oxide, tin oxide and silicon oxide, having a rutile-type crystal structure and having a mean particle size of from 1 to 200 nm.

Using composite oxide particles containing titanium oxide and having a rutile-type crystal structure as the metal oxide particles for the ingredient (B) not only increases the refractive index of the first primer layer 11 but also enhances the weather resistance and the light resistance thereof. Rutile-type crystal has a higher refractive index than anatase-type crystal. Therefore, it may be said that composite oxide particles containing titanium oxide and having a rutile-type crystal structure can be metal oxide particles having a relatively high refractive index.

Preferably, the metal oxide particles for the ingredient (B) are surface-treated with an organosilicon compound having an alkyl group such as a methyl group. As the alkyl group-having organosilicon compound, preferred are those having an alkyl group of the organosilicon compounds for use for the ingredient (C) to be mentioned hereinunder.

Using metal oxide particles surface-treated with an alkyl group-having organosilicon compound enhances the compatibility of the particles with a polyurethane resin for the ingredient (A), therefore enhancing the homogeneousness of the layer, and after all preventing the generation of interference fringes and further enhancing the impact resistance of the structure. When the homogeneousness of the first primer layer 11 is enhanced, the homogeneousness of the voids to be filled with the organosilicon compound for the ingredient (C) is also enhanced, and as a result, the refractive index of the first primer layer 11 can be increased more and the layer can more effectively prevent the generation of interference fringes.

The type and the amount of the metal oxide particles for the ingredient (B) to be incorporated are determined depending on the intended refractive index and the hardness of the layer. As so mentioned in the above, the metal oxide particles for the ingredient (B) preferably has a mean particle size of from 5 to 50 nm, more preferably from 10 to 20 nm. When the mean particle size is less than 5 nm or more than 50 nm, then the particles could not exhibit the synergistic effect thereof with the ingredient (A) and also with the ingredient (C) to be mentioned hereinunder, and if so, it may be difficult to effectively increase the refractive index of the first primer layer 11. The mean particle size of the metal oxide particles for the ingredient (B) may be determined according to a light scattering method, as described in the above.

The blend ratio of the metal oxide particles for the ingredient (B) (the proportion of the ingredient (B) in the first material (first coating composition), or the proportion of the ingredient (B) to all the ingredients (A) to (C)) is preferably from 40 to 80% by weight, more preferably from 50 to 60% by weight. When the blend ratio of the metal oxides is too small, the refractive index and the abrasion resistance of the first primer layer 11 may be low. On the other hand, when the blend ratio is too much, the impact resistance of the first primer layer 11 may lower and the layer may be cracked. In such a case, when the layer is tinted, its tintability may worsen. When the proportion of the metal oxide particles for the ingredient (B) to all the ingredients (A) to (C) is defined to fall from 40 to 80% by weight, then the refractive index of the first primer layer 11 can be sufficiently high and the crosslinking density of the first primer layer 11 can be kept on a suitable level, not detracting from the hardness and the impact resistance of the layer.

The organosilicon compound for the ingredient (C) fills the voids in the first primer layer 11, thereby increasing the density of the first primer layer 11 as a whole and contributing toward increasing the refractive index of the layer. For the organosilicon compound for the ingredient (C), for example, preferably used is a compound of the following general formula (1):

R¹R²ₙSiX¹₃₋ₙ (1)

wherein R¹ represents an organic group having a polymerizable reactive group; R² represents a hydrocarbon group having from 1 to 6 carbon atoms; X¹ represents a hydrolyzable group; n indicates 0 or 1.

The organosilicon compound of formula (1) includes, for example, vinyltrialkoxysilane, vinyltrichlorosilane, vinyltri(β-methoxyethoxy)silane, allyltrialkoxysilane, acryloxypropyltrialkoxysilane, methacryloxypropyltrialkoxysilane, β-(3,4-epoxycyclohexyl)-ethyltrialkoxysilane, mercaptopropyltrialkoxysilane, γ-aminopropyltrialkoxysilane, γ-glycidoxypropyltrialkoxysilane, phenyltrimethoxysilane, phenyltriethoxysilane, diphenyldimethoxysilane, etc. For the ingredient (C), two or more those organosilicon compounds may be used, as combined.

As the organosilicon compound for the ingredient (C), also usable is a tetrafunctional organosilicon compound of the following general formula (2), such as tetramethoxysilane and tetraethoxysilane, to attain the same effect.

SiX²₄ (2)

wherein X² represents an alkoxy group.

As the organosilicon compound for the ingredient (C), also usable is an epoxy group-having organosilicon compound such as glycidoxymethyltrimethoxysilane, glycidoxymethyltriethoxysilane, α-glycidoxyethyltrimethoxysilane, α-glycidoxyethyltriethoxysilane, β-glycidoxyethyltriethoxysilane, β-glycidoxypropyltrimethoxysilane, α-glycidoxypropyltrimethoxysilane, α-glycidoxypropyltriethoxysilane, β-glycidoxypropyltriethoxysilane, γ-glycidoxypropyltrimethoxysilane, (3,4-epoxycyclohexyl)methyltrimethoxysilane, γ-glycidoxypropylvinyldiethoxysilane, γ-glycidoxypropylphenyldiethoxysilane, δ-(3,4-epoxycyclohexyl)butyltriethoxysilane, etc. Using this enhances the adhesiveness between the plastic lens substrate 10 and the hard coat layer 13. In case where the organosilicon compound for the ingredient (C) has an epoxy group, the crosslinking density of the first primer layer 11 does not increase too much and can be controlled on a suitable level, and therefore the first primer layer 11 formed can have good impact resistance.

Further, for the organosilicon compound for the ingredient (C), it is also effective to use an organoalkoxysilane compound as an unhydrolyzed monomer. As compared with the corresponding compound hydrolyzed to have an increased molecular weight, the organoalkoxysilane compound as an unhydrolyzed monomer can more readily filled in the voids in the first primer layer 11. Accordingly, in the case, the refractive index of the first primer layer 11 can be higher, and even when an episulfide-based plastic lens substrate 10 having a refractive index of at least 1.7 is used, the structure can well prevent the generation of interference fringes.

Preferably, the mean particle size of the organosilicon compound for the ingredient (C) is at most 5 nm, more preferably at most 1 nm. When the mean particle size thereof is more than 5 nm, then the compound could not exhibit the synergistic effect thereof with the ingredient (A) and the ingredient (B), and it may be difficult to effectively increase the refractive index of the primer layer. The mean particle size of the organosilicon compound for the ingredient (C) can be determined according to a light scattering method, as described in the above.

The blend ratio of the organosilicon compound for the ingredient (C) (the proportion of the ingredient (C) in the first material (first coating composition), or that is, the proportion of the ingredient (C) to all the ingredients (A) to (C)) is preferably from 0.1 to 5% by weight. When the proportion of the organosilicon compound for the ingredient (C) is less than 0.1% by weight, then the adhesiveness between the plastic lens substrate 10 and the hard coat layer 13 may be insufficient. If so, in addition, the voids in the layer could not be completely filled up, and the refractive index of the layer could not be increased. On the other hand, when the proportion of the organosilicon compound for the ingredient (C) is more than 5% by weight, then the abrasion resistance of the layer may worsen. If so, in addition, the voids in the layer may be filled excessively, and therefore the refractive index of the layer may lower.

In applying the above-mentioned first material (first coating composition, first primer composition) to the plastic lens substrate 10, it is effective to pre-treat the surface of the plastic lens substrate 10, for example, through alkali treatment, acid treatment, surfactant treatment, peeling/polishing treatment with inorganic or organic particles or plasma treatment, for the purpose of enhancing the adhesiveness between the plastic lens substrate 10 and the first primer layer 11 to be formed thereon.

As one example of the coating method and the curing method with the first material, herein mentioned is a method comprising applying the first material to the substrate according to a dipping method, a spin coating method, a spray coating method, a roll coating method, a flow coating method or the like, followed by heating and drying it at a temperature of from 40 to 200° C. for a few hours. In that manner, the first material can form the first primer layer 11.

The first material (first coating composition, first primer composition) to form the first primer layer 11 may be diluted in a solvent before use, if desired. The solvent usable for it includes alcohols, esters, ketones, ethers, aromatic solvents, etc. In addition to the above-mentioned ingredients, a small amount of any other optional additives may be added to the first material, if desired. The additives include metal chelate compound, surfactant, antistatic agent, UV absorbent, antioxidant, disperse dye, oil-soluble dye, pigment, photochromic compound, hindered amine or hindered phenol-based light-resistant heat-resistant stabilizer, etc. They may enhance the coatability and the curability of the first material (coating liquid) and may improve the quality of the cured coating film.

The thickness of the first primer layer 11 is preferably within a range of from 0.05 to 1 μm, more preferably from 0.05 to 0.1 μm. When the first primer layer 11 is too thin, then the water resistance and the impact resistance thereof may lower; but on the contrary, when too thick, the surface smoothness of the layer may worsen, often causing outward faults such as optical strain, cloudiness, fogginess, etc.

By applying the above-mentioned first material to the plastic lens substrate 10, the first primer layer 11 is formed, the refractive index of which decreases in the direction to be remoter from the plastic lens substrate 10. From the viewpoint of preventing interference fringes, the difference between the refractive index of the first primer layer 11 nearer to the plastic lens substrate 10 and the refractive index of the plastic lens substrate 10 is preferably at most 0.01. Also preferably, the difference between the refractive index of the surface part of the first primer layer 11 (nearer to the second primer layer) and the refractive index of the second primer layer is at most 0.01.

### 3. Second Primer Layer

The second primer layer 12 is formed on the surface of the first primer layer 11, and has a property of exhibiting impact resistance. The second primer layer 12 also has a property of exhibiting adhesiveness between the plastic lens substrate 10 and the hard coat layer 13.

The second primer layer 12 is, for example, formed of a second material (second coating composition, second primer composition) comprising the following ingredients (D) and (E):

(D) Urethane-based, ester-based, epoxy-based, acryl-based or silicone-based organic resin, and

(E) Metal oxide particles (metal oxide sol).

The organic resin (organic resin ingredient) for the ingredient (D) exhibits good adhesiveness between the plastic lens substrate 10 and the hard coat layer 13. The metal oxide particles for the ingredient (E) contribute toward the refractivity of the second primer layer 12 and act to increase the crosslinking density of the second primer layer 12 as a filler, therefore contributing toward enhancing the water resistance, the weather resistance and the light resistance of the layer.

An urethane bond-having urethane-based organic resin and an ester bond-having ester-based organic resin have a polar group bonding to the main chain skeleton thereof. An epoxy group-having epoxy-based organic resin has a polar group introduced into the part branched from the main chain skeleton thereof. In case where the second material contains a polar group-having organic resin as the ingredient (D), then the polar group interacts with the thiourethane bond or the episulfide group in the surface of the plastic lens substrate 10 and with the epoxy group or the silanol group in the surface of the hard coat layer 13, therefore expressing good adhesiveness. For attaining further better adhesiveness, the organic resin for the ingredient (D) is preferably an urethane-based or ester-based organic resin.

The metal oxide particles for the ingredient (E) may be the same as the metal oxide particles for the ingredient (B). By using composite oxide particles containing titanium oxide and having a rutile-type crystal structure as the metal oxide particles for the ingredient (E), a second primer layer 12 having excellent weather resistance and light resistance can be formed. In addition, since the rutile-type structure has a higher refractive index than an anatase-type structure, the content of the metal oxide particles for the ingredient (E) to be in the second primer layer 12 can be reduced, and the content of the ingredient (D) (organic resin) therein capable of contributing toward impact resistance and adhesiveness can be increased.

In this embodiment, the condition for the increased refractivity of the second primer layer 12 is relaxed more than that of the first primer layer 11. Accordingly, in the second primer layer 12, the amount of the metal oxide particles for the ingredient (E) can be reduced. Even when metal oxide particles containing tin oxide, whose photoactive effect is poorer than that of titanium oxide, are used, the content thereof can be reduced, and not only the light resistance but also the durability and the shock absorbability of the layer can be enhanced.

As one example of the coating method and the curing method with the second material, herein mentioned is a method comprising applying the second material according to a dipping method, a spin coating method, a spray coating method, a roll coating method, a flow coating method or the like, followed by heating and drying it at a temperature of from 40 to 200° C. for a few hours. In that manner, the second material can form the second primer layer 12.

The second material (second coating composition, second primer composition) to form the second primer layer 12 may be diluted in a solvent before use, if desired. The solvent usable for it includes alcohols, esters, ketones, ethers, aromatic solvents, etc. In addition to the above-mentioned ingredients, a small amount of any other optional additives may be added to the second material, if desired. The additives include metal chelate compound, surfactant, antistatic agent, UV absorbent, antioxidant, disperse dye, oil-soluble dye, pigment, photochromic compound, hindered amine or hindered phenol-based light-resistant heat-resistant stabilizer, etc. They may enhance the coatability and the curability of the second material (coating liquid) and may improve the quality of the cured coating film.

The thickness of the second primer layer 12 is preferably within a range of from 0.05 to 5.0 μm. More preferably, the thickness of the second primer layer 12 is within a range of from 2.0 to 3.0 μm. When the second primer layer 12 is too thin, then the water resistance and the impact resistance thereof may lower; but on the contrary, when too thick, the surface smoothness of the layer may worsen, often causing outward faults such as optical strain, cloudiness, fogginess, etc. When its thickness falls within the above-mentioned range, then the second primer layer 12 may exhibit good impact resistance. From the viewpoint of preventing interference fringes, the difference between the refractive index of the second primer layer 12 and the refractive index of the hard coat layer 13 is preferably at most 0.01.

### 4. Hard Coat Layer

The hard coat layer 13 is formed on the surface of the second primer layer 12, and has a property of exhibiting scratch resistance and abrasion resistance. The hard coat layer 13 is, for example, formed of a third material (third coating composition, hard coat composition, coating film composition) comprising the following (F) and (G). The third material may contain the following (H):

(F) Organosilicon compound,

(G) Metal oxide particles (metal oxide sol), and

(H) Additives such as colorant, UV absorbent, antioxidant, etc.

For the organosilicon compound for the ingredient (F), for example, usable is a silicone-based curable resin. The organosilicon compound for the ingredient (F) may be the same as the organosilicon compound for the ingredient (C). Specifically, for the organosilicon compound for the ingredient (F), for example, preferred are the compounds of formula (1) mentioned in the above. The organosilicon compound for the ingredient (F) serves as a binder in the hard coat layer 13, but for attaining better adhesiveness, R¹ in formula (1) is preferably an epoxy group. For attaining better scratch resistance, R² in formula (1) is preferably a methyl group.

The metal oxide particles for the ingredient (G) may be the same as the metal oxide particles for the ingredients (B) and (E).

In preparing the third material (coating composition for forming hard coat layer, hard coat liquid) that comprises an organosilicon compound for the ingredient (F) and metal oxide particles for the ingredients (G), preferably, a sol of metal oxide particles dispersed therein is mixed with an organosilicon compound. The blend ratio of the metal oxide particles is determined depending on the hardness and the refractive index of the hard coat layer to be formed, and is preferably from 5 to 80% by weight of the solid content of the third material, more preferably from 10 to 60% by weight. When the blend ratio is too small, then the abrasion resistance and the refractive index of the hard coat layer 13 may be insufficient; but when too much, the hard coat layer 13 may crack. In addition, in case where the hard coat layer 13 is tinted, the tintability thereof may be poor.

Extremely usefully, the hard coat layer 13 contains not only the organosilicon compound for the ingredient (F) and the metal oxide particles for the ingredient (G) but also a polyfunctional epoxy compound as an additional organic resin ingredient (ingredient (I)). The polyfunctional epoxy compound enhances the adhesiveness of the hard coat layer 13 to the second primer layer 12, and enhances the water resistance of the hard coat layer 13 and the impact resistance of the plastic lens 1.

The polyfunctional epoxy compound includes, for example, an aliphatic epoxy compound such as 1,6-hexanediol diglycidyl ether and ethylene glycol diglycidyl ether; alicyclic epoxy compound such as isophoronediol diglycidyl ether and bis-2,2-hydroxycyclohexylpropane diglycidyl ether; aromatic epoxy compound such as resorcinol diglycidyl ether, bisphenol A diglycidyl ether and cresol-novolak polyglycidyl ether; etc.

Further, a curing catalyst may be added to the third material to form the hard coat layer 13. The curing catalyst includes, for example, perchloric acid and its derivatives such as perchloric acid, ammonium perchlorate and magnesium perchlorate; acetylacetonates with a center metal atom such as Cu(II), Zn(II), Co(II), Ni(II), Be(II), Ce(III), Ta(III), Ti(III), Mn(III), La(III), Cr(III), V(III), Co(III), Fe(III), Al(III), Ce(IV), Zr(IV), V(IV) or the like; amines; amino acids glycine; Lewis acids; organic acid metal salts; etc.

The third material to form the hard coat layer 13 (coating composition for forming hard coat layer) may be diluted in a solvent before use, if desired. The solvent usable for it includes alcohols, esters, ketones, ethers, aromatic solvents, etc. In addition to the above-mentioned ingredients, a small amount of any other optional additives may be added to the coating composition for forming hard coat layer, if desired. The additives include metal chelate compound, surfactant, antistatic agent, UV absorbent, antioxidant, disperse dye, oil-soluble dye, pigment, photochromic compound, hindered amine or hindered phenol-based light-resistant heat-resistant stabilizer, etc. They may enhance the coatability and the curability of the coating liquid and may improve the quality of the cured coating film.

For the coating method and the curing method with the third material, herein mentioned is a method comprising applying the coating composition according to a dipping method, a spin coating method, a spray coating method, a roll coating method, a flow coating method or the like, followed by heating and drying it at a temperature of from 40 to 200° C. for a few hours.

The thickness of the hard coat layer 13 is preferably within a range of from 0.05 to 30 μm. When the thickness of the hard coat layer 13 is less than 0.05 μm, then the basic performance (scratch resistance, abrasion resistance, etc.) could not be realized. When the thickness of the hard coat layer 13 is more than 30 μm, then surface smoothness of the layer may worsen, often causing optical strain.

### 5. Antireflection Layer

The antireflection layer 14 is an optional thin layer to be formed on the hard coat layer 13, if desired. The antireflection layer 14 may be formed, for example, by alternately laminating a low-refractivity layer having a refractive index of from 1.3 to 1.5 and a high-refractivity layer having a refractive index of from 1.8 to 2.3. The number of the constitutive layers is preferably from 5 to 7 or so.

Examples of the inorganic substance to be used in each layer constituting the antireflection layer 14 include SiO₂, SiO, ZrO₂, TiO₂, TiO, Ti₂O₃, Ti₂O₅, Al₂O₃, TaO₂, Ta₂O₅, NbO, Nb₂O₃, NbO₂, Nb₂O₅, CeO₂, MgO, Y₂O₃, SnO₂, MgF₂, WO₃, etc. One or more of these inorganic substances may be used either singly or as combined. One example of the antireflection layer 14 comprises a low-refractivity layer of SiO₂ and a high-refractivity layer of ZrO₂.

For forming the antireflection layer 14, employable is a dry method, for example, a vacuum evaporation method, an ion plating method, sputtering method or the like. The vacuum evaporation method may be combined with an ion beam-assisted method that comprises simultaneous ion beam radiation during vapor deposition.

The antireflection film 14 may be formed according to a wet method. For example, a coating composition for forming antireflection layer, which comprises silica particles having inner voids (hereinafter this may be referred to as “hollow silica particles”) and an organosilicon compound, may be applied according to the same coating method as that for the first primer layer 11, the second primer layer 12, or the hard coat layer 13.

In this, hollow silica particles are used. This is because the hollow silica particles contain, in the inner voids thereof, a vapor or solvent having a lower refractive index than silica, and as compared with non-hollow silica particles, the hollow silica particles can have a lower refractive index, as a result, therefore capable of imparting an excellent antireflection effect to the layer. The hollow silica particles can be produced according to the method described in JP-A-2001-233611. Preferred are those having a mean particle size of from 1 to 150 nm and a refractive index of from 1.16 to 1.39. As the organosilicon compound, preferred is the compounds of formula (1) mentioned in the above. The thickness of the antireflection layer 14 is preferably within a range of from 50 to 150 nm. When the layer is thinner or thicker than the range, then it could not exhibit a sufficient antireflection effect.

### 6. Antifouling Layer

For the purpose of enhancing the water-repellent oil-repellent capability of the surface of the optical article 1, an antifouling layer comprising a fluorine-containing organosilicon compound may be formed on the antireflection layer 14. For the fluorine-containing organosilicon compound, for example, preferred are fluorosilane compounds described in JP-A-2005-301208 and JP-A-2006-126782.

Preferably, the fluorosilane compound is dissolved in an organic solvent to give a water repellency treatment liquid (coating composition for forming antifouling layer) having a predetermined concentration for use herein. The antifouling layer maybe formed by applying the water repellency treatment liquid (coating composition for forming antifouling layer) onto the antireflection layer 14. For the coating method, employable is a dipping method, a spin coating method or the like. The water repellency treatment liquid (coating composition for forming antifouling layer) may be filled in metal pellets, with which the antifouling layer may be formed according to a dry method such as a vacuum evaporation method,

Not specifically defined, the thickness of the antifouling layer is preferably from 0.001 to 0.5 μm, more preferably from 0.001 to 0.03 μm. When the antifouling layer is too thin, then its water-repellent oil-repellent effect may be poor; but when too thick, then its surface may be sticky and is unfavorable. In addition, when the thickness of the antifouling layer is more than 0.03 μm, then the antireflection effect of the structure may lower.

According to this embodiment, a high-refractivity plastic substrate 10 having a refractive index of at least 1.7 can be used; and in addition, since the first primer layer 11, the second primer layer 12 and the hard coat layer 13 are formed on the plastic substrate 10, there is provided an optical article (plastic lens for spectacles) 1 which is extremely thin and is excellent in impact resistance and which has few interference fringes.

In general, when the refractive index of the primer layer is increased in accordance with the refractive index of the plastic lens substrate, then the difference between the refractive index of the primer layer and the refractive index of the hard coat layer increases, therefore often causing interference fringes. This is because the refractive index of the hard coat layer is difficult to increase. As opposed to this, according to this embodiment of the invention, the optical article has few interference fringes. This may be because the refractive index of the first primer layer 11 in this embodiment is so designed that it gradually decreases from the bulk layer (inner layer) 11a to the surface layer (surface part) 11b and the difference between the refractive index of the outermost surface part of the first primer layer 11 and the refractive index of the hard coat layer 13 is reduced. In particular, when the mean particle size of the ingredient (A) and the ingredient (B) is both from 5 to 50 nm, and when the mean particle size of the ingredient (C) is at most 5 nm, this effect is remarkable. Accordingly in the invention, it is unnecessary to forcedly increase the refractive index of the hard coat layer 13, and the latitude in planning the hard coat layer 13 is broadened.

### EXAMPLES

The invention is described in more detail with reference to the following Examples 1 to 7 and Comparative Examples 1 and 2. The plastic lenses 1 produced in Examples 1 to 7 and Comparative Examples 1 and 2 were evaluated in point of the interference fringes, the adhesiveness and the impact resistance thereof.

### Example 1

### Step (1) Formation of Plastic Lens Substrate 10

In a nitrogen atmosphere, 90 parts by weight of bis(β-epithiopropyl) disulfide and 10 parts by weight of sulfur were mixed and stirred at 100° C. for 1 hour. After cooled, 0.05 parts by weight of a catalyst, tetrabutylammonium bromide was mixed with it to prepare a uniform liquid. Next, this was filtered through a 0.5-μm PTPE filter, then cast into a glass mold for 1.2 mm-thick lens formation, heated in an oven from 10° C. up to 120° C. for polymerization and curing, taking 22 hours, thereby producing a plastic lens substrate 10. Thus obtained, the plastic lens substrate 10 had a refractive index of 1.74 and an Abbe number of 33. The plastic lens substrate 10 was transparent and its surface condition was good.

### Step (2) Preparation of First Primer Composition (First Material)

2900 parts by weight of methyl alcohol and 50 parts by weight of aqueous solution of 0.1 N sodium hydroxide were put into a stainless container, well stirred, and, as the ingredient (B), 1500 parts by weight of composite particle sol mainly comprising titanium oxide, tin oxide and silicon oxide (rutile-type crystal structure, methanol dispersion, surface-treating agent γ-glycidoxypropyltrimethoxysilane, total solid concentration 20% by weight, manufactured by Catalysts & Chemicals Co., trade name: Optolake) was added thereto, and stirred and mixed. Next, as the ingredient (A), 580 parts by weight of polyurethane resin (water dispersion, total solid concentration 35% by weight, manufactured by Daiichi Kogyo Seiyaku, trade name: Superflex 210); and as the ingredient (C), 35 parts by weight of γ-glycidoxypropyltrimethoxysilane were added thereto, and stirred and mixed, and then 2 parts by weight of silicone-based surfactant (manufactured by Toray Dow Corning, trade name: L-7604) was added thereto and kept stirred for one night and day. Next, this was filtered through a 2-μm filter to give a first primer composition (first coating composition, first material).

### Step (3) Preparation of Second Primer Composition (Second Material)

3700 parts by weight of methyl alcohol, 250 parts by weight of pure water and 1000 parts by weight of propylene glycol monomethyl ether were put into a stainless container, well stirred, and, as the ingredient (E), 2800 parts by weight of composite particle sol mainly comprising titanium oxide, tin oxide and silicon oxide (rutile-type crystal structure, methanol dispersion, surface-treating agent γ-glycidoxypropyltrimethoxysilane, total solid concentration 20% by weight, manufactured by Catalysts & Chemicals Co., trade name: Optolake) was added thereto, and stirred and mixed. Next, as the ingredient (D), 2200 parts by weight of polyester resin (water dispersion, total solid concentration 38% by weight) was added thereto, and stirred and mixed, and then 2 parts by weight of silicone-based surfactant (manufactured by Toray Dow Corning, trade name: L-7604) was added thereto and kept stirred for one night and day. Next, this was filtered through a 2-μm filter to give a second primer composition (second coating composition, second material).

### Step (4) Preparation of Hard Coat Composition (Third Material)

1000 parts by weight of butyl cellosolve was put into a stainless container, and as the ingredient (F), 1200 parts by weight of γ-glycidoxypropyltrimethoxysilane was added thereto, well stirred, and then 300 parts by weight of aqueous solution of hydrochloric acid (0.1 mol/liter) was added thereto, and kept stirred for one night and day to give a silane hydrolyzate. 30 parts by weight of silicone-based surfactant (manufactured by Toray Dow Corning, trade name: L-7001) was added to the silane hydrolyzate, stirred for 1 hour, and then, as the ingredient (G), 7300 parts by weight of composite particle sol mainly comprising titanium oxide, tin oxide and silicon oxide (rutile-type crystal structure, methanol dispersion, surface-treating agent γ-glycidoxypropyltrimethoxysilane, manufactured by Catalysts & Chemicals Co., trade name: Optolake) was added thereto, and stirred and mixed for 2 hours. Next, as the ingredient (I), 250 parts by weight of epoxy resin (manufactured by Nagase Chemical, trade name: EX-313) was added thereto, stirred for 2 hours, and then 20 parts by weight of iron(III) acetylacetonate was added thereto and stirred for 1 hour. Next, this was filtered through a 2-μm filter to give a hard coat composition (third coating composition, third material)

### Step (5) Formation of First Primer Layer, Second Primer Layer, Hard Coat Layer and Antireflection Film

The plastic lens substrate 10 having a diameter of 80 mm, as prepared in the above (1), was treated with alkali (by dipping it in aqueous solution of potassium hydroxide (2 mol/liter) kept at 50° C. for 5 minutes, then washing it with pure water, and dipping it in sulfuric acid (1.0 mol/liter) kept at 25° C. for 1 minute for neutralization), and washed with pure water, dried and left cooled.

The alkali-treated plastic lens substrate 10 was dipped in the first primer composition prepared in the above (2), for dip coating with it at a drawing speed of 150 mm/min. Next, this was baked at 80° C. for 20 minutes, to thereby form a first primer layer 11 on the surface of the plastic lens substrate 10.

Next, the plastic lens substrate 10 with the first primer layer 11 formed thereon was dipped in the second primer composition prepared in the above (3), for dip coating with it at a drawing speed of 220 mm/min. Next, this was baked at 80° C. for 20 minutes, to thereby form a second primer layer 12 on the surface of the first primer layer 11.

Further, the plastic lens substrate 10 with the first and second primer layers 11 and 12 formed thereon was dipped in the hard coat composition prepared in the above (4), for dip coating with it at a drawing speed of 400 mm/min. Next, this was baked at 80° C. for 30 minutes, to thereby form a hard coat layer 13 on the surface of the second primer layer 12.

Next, this was heated in an oven kept at 125° C. for 3 hours, thereby giving a plastic lens (work) with the first primer layer 11, the second primer layer 12 and the hard coat layer 13 formed thereon.

Next, the work with the surface treatment layers (the first primer layer 11, the second primer layer 12, and the hard coat layer 13) formed thereon was plasma-treated (argon plasma 400 W×60 seconds), and then a multilayer-structured antireflection layer 14 composed of five layers of SiO₂, ZrO₂, SiO₂, ZrO₂ and SiO₂ in that order from the hard coat layer 13 toward the surface thereof was formed thereon using a vacuum evaporator (manufactured by Shincron). Regarding the optical thickness of each layer, the constitutive layers were so formed that the first SiO₂ layer, the next equivalent layer of ZrO₂ and SiO₂, the next ZrO₂ layer, and the outermost SiO₂ layer each could have a thickness of λ/4 with a planned wavelength λ of 520 nm. Accordingly, a plastic lens 1 having the first primer layer 11, the second primer layer 12, the hard coat layer 13 and the antireflection layer 14 was produced.

### Example 2

In preparing the first primer composition in the step (2) in Example 1, the ingredient (B), composite particle sol (rutile-type crystal structure, methanol dispersion, surface-treating agent γ-glycidoxypropyltrimethoxysilane, total solid concentration 20% by weight, manufactured by Catalysts & Chemicals Co., trade name: Optolake) was changed to composite particle sol (rutile-type crystal structure, methanol dispersion, surface-treating agent methyltrimethoxysilane, total solid concentration 20% by weight, manufactured by Catalysts & Chemicals Co., trade name: Optolake). In the same manner as in Example 1 except this, a plastic lens 1 was produced. Accordingly, also in Example 2, a plastic lens 1 having the first primer layer 11, the second primer layer 12, the hard coat layer 13 and the antireflection layer 14 was produced.

### Example 3

In preparing the second primer composition in the step (3) in Example 1, the ingredient (E), composite particle sol (rutile-type crystal structure, methanol dispersion, surface-treating agent γ-glycidoxypropyltrimethoxysilane, total solid concentration 20% by weight, manufactured by Catalysts & Chemicals Co., trade name: Optolake) was changed to composite particle sol (rutile-type crystal structure, methanol dispersion, surface-treating agent methyltrimethoxysilane, total solid concentration 20% by weight, manufactured by Catalysts & Chemicals Co., trade name: Optolake). In the same manner as in Example 1 except this, a plastic lens 1 was produced. Accordingly, also in Example 3, a plastic lens 1 having the first primer layer 11, the second primer layer 12, the hard coat layer 13 and the antireflection layer 14 was produced.

### Example 4

In preparing the second primer composition in the step (3) in Example 1, the ingredient (D), polyester resin (water dispersion, total solid concentration 38% by weight) was changed to polyurethane resin (water dispersion, total solid concentration 38% by weight, manufactured by Daiichi Kogyo Seiyaku, trade name: Superflex 460). In the same manner as in Example 1 except this, a plastic lens 1 was produced. Accordingly, also in Example 4, a plastic lens 1 having the first primer layer 11, the second primer layer 12, the hard coat layer 13 and the antireflection layer 14 was produced.

### Example 5

In the step (2) in Example 1, the first primer composition was prepared as follows: 6268 parts by weight of methyl alcohol and 100 parts by weight of aqueous solution of 0.1 N sodium hydroxide were put into a stainless container, and well stirred, and, as the ingredient (B), 2700 parts by weight of composite particle sol mainly comprising titanium oxide, tin oxide and silicon oxide (rutile-type crystal structure, methanol dispersion, surface-treating agent methyltrimethoxysilane, total solid concentration 20% by weight, manufactured by Catalysts & Chemicals Co., trade name: Optolake) was added thereto, and stirred and mixed. Next, as the ingredient (A), 815 parts by weight of polyurethane resin (total of 424 parts by weight of water dispersion, total solid concentration 35% by weight, manufactured by Daiichi Kogyo Seiyaku, trade name: Superflex 210, and 391 parts by weight of water dispersion, total solid concentration 38% by weight, manufactured by Daiichi Kogyo Seiyaku, trade name: Superflex 460); and as the ingredient (C), 97 parts by weight of phenyltrimethoxysilane (manufactured by Shin-etsu Chemical Industry, trade name: KBM-103) (corresponding to 7% by weight in the first primer layer 11) were added thereto, and stirred and mixed, and then 2 parts by weight of silicone-based surfactant (manufactured by Toray Dow Corning, trade name: L-7604) was added thereto and kept stirred for one night and day. Next, this was filtered through a 2-μm filter to give a first primer composition. In the same manner as in Example 1 except this, a plastic lens 1 was produced. Accordingly also in Example 5, a plastic lens 1 having the first primer layer 11, the second primer layer 12, the hard coat layer 13 and the antireflection layer 14 was produced. This differs from the plastic lens in Example 1 only in the composition of the first primer layer 11.

### Example 6

In the step (2) in Example 1, the first primer composition was prepared as follows: 6248 parts by weight of methyl alcohol and 100 parts by weight of aqueous solution of 0.1 N sodium hydroxide were put into a stainless container, and well stirred, and, as the ingredient (B), 2700 parts by weight of composite particle sol mainly comprising titanium oxide, tin oxide and silicon oxide (rutile-type crystal structure, methanol dispersion, surface-treating agent methyltrimethoxysilane, total solid concentration 20% by weight, manufactured by Catalysts & Chemicals Co., trade name: Optolake) was added thereto, and stirred and mixed. Next, as the ingredient (A), 815 parts by weight of polyurethane resin (total of 424 parts by weight of water dispersion, total solid concentration 35% by weight, manufactured by Daiichi Kogyo Seiyaku, trade name: Superflex 210, and 391 parts by weight of water dispersion, total solid concentration 38% by weight, manufactured by Daiichi Kogyo Seiyaku, trade name: Superflex 460); and as the ingredient (C), 117 parts by weight of phenyltrimethoxysilane (manufactured by Shin-etsu Chemical Industry, trade name: KBE-103) (corresponding to 7% by weight in the first primer layer 11) were added thereto, and stirred and mixed, and then 2 parts by weight of silicone-based surfactant (manufactured by Toray Dow Corning, trade name: L-7604) was added thereto and kept stirred for one night and day. Next, this was filtered through a 2-μm filter to give a first primer composition. In the same manner as in Example 1 except this, a plastic lens 1 was produced. Accordingly also in Example 6, a plastic lens 1 having the first primer layer 11, the second primer layer 12, the hard coat layer 13 and the antireflection layer 14 was produced. This differs from the plastic lens in Example 1 only in the composition of the first primer layer 11.

### Example 7

In the step (2) in Example 1, the first primer composition was prepared as follows: 6287 parts by weight of methyl alcohol and 100 parts by weight of aqueous solution of 0.1 N sodium hydroxide were put into a stainless container, and well stirred, and, as the ingredient (B), 2700 parts by weight of composite particle sol mainly comprising titanium oxide, tin oxide and silicon oxide (rutile-type crystal structure, methanol dispersion, surface-treating agent methyltrimethoxysilane, total solid concentration 20% by weight, manufactured by Catalysts & Chemicals Co., trade name; Optolake) was added thereto, and stirred and mixed. Next, as the ingredient (A), 815 parts by weight of polyurethane resin (total of 424 parts by weight of water dispersion, total solid concentration 35% by weight, manufactured by Daiichi Kogyo Seiyaku, trade name: Superflex 210, and 391 parts by weight of water dispersion, total solid concentration 38% by weight, manufactured by Daiichi Kogyo Seiyaku, trade name: Superflex 460); and as the ingredient (C), 77 parts by weight of diphenyldimethoxysilane (manufactured by Shin-etsu Chemical Industry, trade name: KBM-202SS) (corresponding to 7% by weight in the first primer layer 11) were added thereto, and stirred and mixed, and then 2 parts by weight of silicone-based surfactant (manufactured by Toray Dow Corning, trade name: L-7604) was added thereto and kept stirred for one night and day. Next, this was filtered through a 2-μm filter to give a first primer composition. In the same manner as in Example 1 except this, a plastic lens 1 was produced. Accordingly also in Example 7, a plastic lens 1 having the first primer layer 11, the second primer layer 12, the hard coat layer 13 and the antireflection layer 14 was produced. This differs from the plastic lens in Example 1 only in the composition of the first primer layer 11.

### Comparative Example 1

The step (2) in Example 1 was omitted. Accordingly, in Comparative Example 1, the first primer layer 11 was not formed. In the same manner as in Example 1 except this, a plastic lens was produced. In Comparative Example 1, a plastic lens was produced, having the second primer layer 12, the hard coat layer 13 and the antireflection layer 14.

### Comparative Example 2

The step (3) in Example 1 was omitted. Accordingly, in Comparative Example 2, the second primer layer 12 was not formed. In the same manner as in Example 1 except this, a plastic lens was produced. In Comparative Example 2, a plastic lens was produced, having the first primer layer 11, the hard coat layer 13 and the antireflection layer 14.

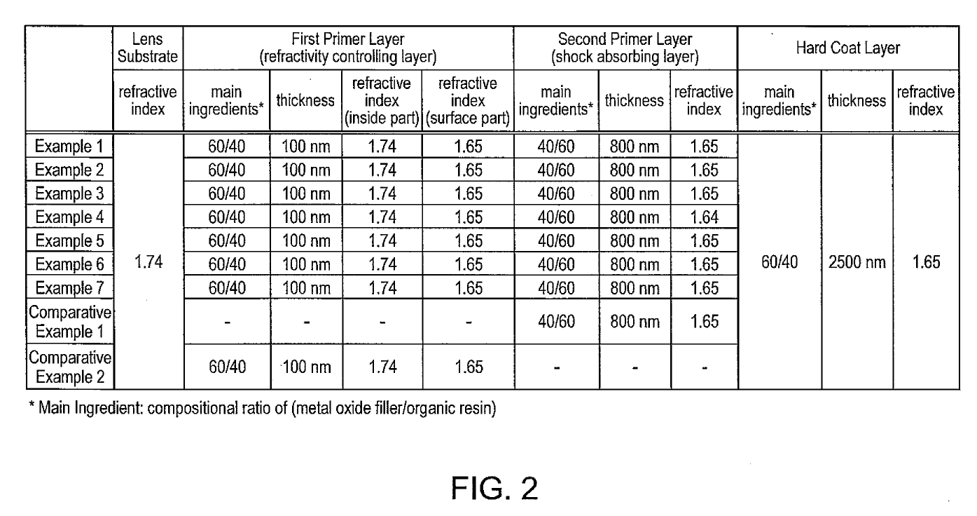

FIG. 2 shows, as summarized, the refractive index of the plastic lens substrate 10, and the compositional ratio, the thickness and the refractive index of the individual layers 11 to 13 of the plastic lenses produced in Examples 1 to 7 and Comparative Examples 1 and 2.

In the plastic lenses 1 produced in Examples 1 to 7, the plastic lens substrate 10 had a refractive index of 1.74.

The compositional ratio of the metal oxide filler (metal oxide particles) to the organic resin (compositional ratio of ingredient (B) to ingredient (A)) in the first primer layer 11 was controlled to 60/40; and the film thickness (layer thickness) of the first primer layer 11 was 100 nm, the refractive index of the inside part 11a of the first primer layer 11 was 1.74, and the refractive index of the surface part 11b of the first primer layer 11 was 1.65.

The compositional ratio of the metal oxide filler (metal oxide particles) to the organic resin (compositional ratio of ingredient (E) to ingredient (D)) in the second primer layer 12 was controlled to 40/60; and the film thickness (layer thickness) of the second primer layer 12 was 800 nm, and the refractive index of the second primer layer 12 was 1.65.

The compositional ratio of the metal oxide filler (metal oxide particles) to the organic resin (compositional ratio of ingredient (G) to ingredient (I)) in the hard coat layer 13 was controlled to 60/40; and the film thickness (layer thickness) of the hard coat layer 13 was 2500 nm, and the refractive index of the hard coat layer 13 was 1.65. In the plastic lens 1 produced in Example 4, the refractive index of the second primer layer 12 was 1.64.

In the plastic lens produced in Comparative Example 1, the refractive index of the plastic lens substrate 10 was 1.74. The compositional ratio of the metal oxide filler (metal oxide particles) to the organic resin in the second primer layer 12 was 40/60; and the film thickness (layer thickness) of the second primer layer 12 was 800 nm, and the refractive index thereof was 1.65. The compositional ratio of the metal oxide filler (metal oxide particles) to the organic resin in the in the hard coat layer 13 was 60/40; and the film thickness (layer thickness) of the hard coat layer 13 was 2500 nm, and the refractive index of the hard coat layer 13 was 1.65.

In the plastic lens produced in Comparative Example 2, the refractive index of the plastic lens substrate 10 was 1.74. The compositional ratio of the metal oxide filler (metal oxide particles) to the organic resin in the first primer layer 11 was 60/40; and the film thickness (layer thickness) of the first primer layer 11 was 100 nm, and the refractive index of the inner part 11a of the first primer layer 11 was 1.74, and the refractive index of the surface part 11b of the first primer layer 11 was 1.65. The compositional ratio of the metal oxide filler (metal oxide particles) to the organic resin in the in the hard coat layer 13 was 60/40; and the film thickness (layer thickness) of the hard coat layer 13 was 2500 nm, and the refractive index of the hard coat layer 13 was 1.65.

### Evaluation:

The plastic lenses produced in Examples 1 to 7 and Comparative Examples 1 and 2 were evaluated according to the following test methods.

### (a) Interference Fringes:

Irradiated with a three-wavelength fluorescent lamp (manufactured by Panasonic, trade name: National Palook) in a dark box, the plastic lens was checked for interference fringes, and evaluated as based on the following ranks:

A: Few interference fringes were seen, and the lens was on a good level.

B: Many interference fringes were seen, and the lens was on a bad level.

### (b) Adhesiveness

The plastic lens was exposed to a sunshine weather meter (manufactured by Suga Test Instruments, WEL-SUN-HC) with a xenon lamp for 80 hours, and then tested according to a cross-cut tape test of JIS D-0202. Briefly, the plastic lens surface was cut at intervals of 1 mm to form 100 cross-cuts of 1 mm² each. An adhesive cellophane tape (manufactured by Nichiban, trade name: Cellotape®) was firmly pressed to it. Next, the tape was rapidly peeled away in the direction of 90 degrees from the surface. The cross-cuts of the coating film still remaining on the surface were counted for the index of the coating film adhesiveness of the tested lens.

A: No cross-cut peeled (100 cross-cuts remained).

B: Few cross-cut peeled (from 95 to 99.9 cross-cuts remained).

C: A few cross-cuts peeled (from 80 to 94.9 cross-cuts remained).

D: Some cross-cuts peeled (from 30 to 79.9 cross-cuts remained).

E: Almost all cross-cuts peeled (from 0 to 29.9 cross-cuts remained).

### (c) Impact Resistance

According to US FDA Standard, the plastic lens was tested with a falling ball. Briefly, a steel ball having a mass of 16.3 g was dropped onto the plastic lens kept its convex surface upside, from a height of 67 cm in the vertical direction thereto. The lens not broken was again tested with the same ball by stepwise increasing the ball dropping height by 20 cm. The height at which the lens was broken was measured. In the test, the center thickness of the plastic lens substrate was 1.1 mm.

### Test Results:

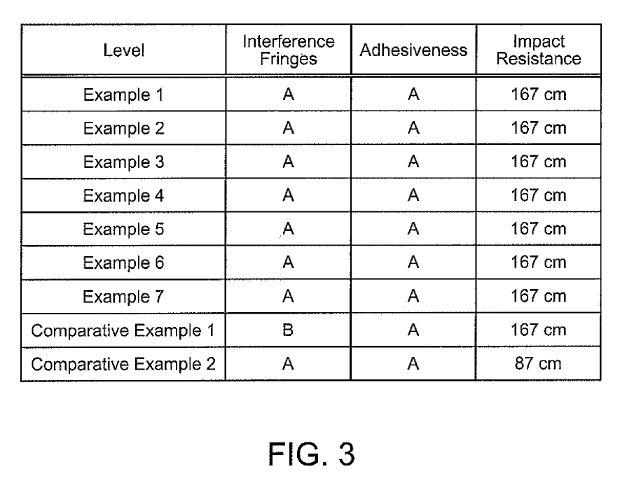

FIG. 3 shows, as summarized, the test results of the plastic lenses of Examples 1 to 7 and Comparative Examples 1 and 2.

The plastic lenses 1 produced in Examples 1 to 7 gave no interference fringes. The result may be because the refractive index of the first primer layer 11 was suitably controlled. Specifically, the plastic lenses 1 produced in Examples 1 to 7 had the first primer layer 11 formed therein, and owing to the first primer layer 11, therefore, the refractive index of the plastic lens 1 can change almost continuously from the plastic lens substrate 10 to the hard coat layer 13 with no significant refractivity difference therebetween. Accordingly, it may be considered that, in the interface between the plastic lens substrate 10 and the first primer layer 11, in the interface between the first primer layer 11 and the second primer layer 12, and in the interface between the second primer layer 12 and the hard coat layer 13, the generation of interference fringes could be prevented.

In addition, the plastic lenses 1 produced in Examples 1 to 7 had good impact resistance. The plastic lenses 1 produced in Examples 1 to 7 had the second primer layer 12 formed therein, and it may be considered that the second primer layer 12 could absorb shock given to the lenses. Further, the plastic lenses 1 produced in Examples 1 to 7 had good adhesiveness.

The plastic lens produced in Comparative Example 1 had the second primer layer 12 formed therein, and had good impact resistance (shock absorbability). However, this gave interference fringes. This may be because the plastic lens produced in Comparative Example 1 did not have a first primer layer 11, and therefore, in this, the difference in the refractive index between the plastic lens substrate 10 and the second primer layer 12 is large and the interface between the two gave interference fringes.

The plastic lens produced in Comparative Example 2 had the first primer layer 11 formed therein, and therefore did not give interference fringes in the interface between the constitutive layers. However, since the plastic lens produced in Comparative Example 2 did not have a second primer layer 12, its impact resistance (shock absorbability) was inferior to that of the plastic lenses 1 produced in Examples 1 to 7.

As in the above, the plastic lenses 1 produced in Examples 1 to 7 had the first primer layer 11, and therefore can prevent interference fringes. The refractive index of the first primer layer 11 that the plastic lenses 1 produced in Examples 1 to 7 have decreases in the direction to be remoter from the plastic substrate 10; and therefore, even when the second primer layer 12, the refractive index of which is not larger than the refractive index of the surface part 11b of the first primer layer 11, is provided on the first primer layer 11 and further the hard coat layer 13, the refractive index of which is smaller than that of the substrate 10, is provided thereon, the refractivity gap from the substrate 10 to the hard coat layer 13 in the lenses can be inhibited and therefore the generation of interference fringes can be prevented.

In addition, between the first primer layer 11 and the hard coat layer 13, the second primer layer 12 the refractive index of which is not larger than the refractive index of the surface part 11b of the first primer layer 11, or that is, the primer layer 12 in which the ratio of the metal oxide particles to the organic resin is relatively small (having large shock absorbability) can be provided. Accordingly, the plastic lenses 1 produced in Examples 1 to 7 have good impact resistance.

The optical article of the invention is favorably used for plastic lenses. The optical article of the invention includes, for example, optical lenses such as spectacle lenses, camera lenses, lenses for telescopes, lenses for microscopes, condenser lenses for steppers, lenses for optical instruments, etc. The optical lens to which the invention is applied is not limited to optical lenses. The optical article of the invention includes any other articles through or on which light transmits or reflects, for example, display panels of liquid-crystal display devices, and optical recording media such as DVD, etc.

The entire disclosure of Japanese Patent Application Nos: 2008-075106, filed Mar. 24, 2008 and 2008-232976, filed Sep. 11, 2008 are expressly incorporated by reference herein.

What is claimed is:

1. An optical article comprising a plastic substrate,
a first layer which is adjacent to the plastic substrate and the refractive index of which decreases in the direction to be remoter from the plastic substrate,
a second layer which is adjacent to the first layer and the refractive index of which is not higher than the refractive index of the surface part of the first layer, and
a hard coat layer which is adjacent to the second layer and the refractive index of which is lower than the refractive index of the plastic substrate.

2. The optical article as claimed in claim 1, wherein the first layer is formed of a first material that comprises a polyurethane resin, metal oxide particles and an organosilicon compound.

3. The optical article as claimed in claim 1, wherein the second layer is formed of a second material that comprises an urethane-based, ester-based, epoxy-based, acryl-based or silicone-based organic resin and metal oxide particles.

4. The optical article as claimed in claim 1, wherein the first material to form the first layer, the second material to form the second layer and a third material to form the hard coat layer each contain metal oxide particles and an organic resin, and wherein the ratio of the metal oxide particles to the organic resin in the first material is larger than the ratio of the metal oxide particles to the organic resin in the second material.

5. The optical article as claimed in claim 4, wherein the ratio of the metal oxide particles to the organic resin in the third material is larger than the ratio of the metal oxide particles to the organic resin in the second material.

6. The optical article as claimed in one of the claims 1 to 5, wherein the refractive index of the plastic substrate is at least 1.7.
